(19) United States
(12) Patent Application Publication
(10) Pub. No.: US 2026/0008720 A1
(43) Pub. Date: Jan. 8, 2026

(54) ETCHING DEVICE AND METHOD OF MANUFACTURING WINDOW USING THE SAME

(71) Applicant: Samsung Display Co., LTD., Yongin-si (KR)

(72) Inventors: BYOUNGYUL SHIM, Yongin-si (KR); HYUNCHUL KIM, Yongin-si (KR); KANG DUK CHOI, Yongin-si (KR); SEUNGPYO HONG, Yongin-si (KR)

(21) Appl. No.: 19/247,684

(22) Filed: Jun. 24, 2025

(30) Foreign Application Priority Data
Jul. 5, 2024 (KR) 10-2024-0088976

(51) Int. Cl. C03C 15/02; G06F 1/16

(52) U.S. Cl. CPC C03C 15/02; G06F 1/1618; G06F 1/1652; C03C 2217/20; C03C 2217/78

(57) ABSTRACT

An etching device includes a stage on which a target substrate is disposed, a nozzle part disposed to face the stage with the target substrate interposed therebetween, where the nozzle sprays an etching solution toward the stage, a mask part disposed between the target substrate and the nozzle part, where the mask part includes a first pattern including a first side surface extending in a first direction, and a second pattern spaced apart from the first pattern in a second direction intersecting the first direction and including a second side surface extending in the first direction, and an opening is defined by the first side surface and the second side surface to expose a portion of the target substrate, and a lower cooling part disposed between the stage and the target substrate.

This application claims priority to Korean Patent Application No. 10-2024-0088976, filed on Jul. 5, 2024, and all the benefits accruing therefrom under 35 U.S.C. § 119, the content of which in its entirety is herein incorporated by reference.

### BACKGROUND

### 1. Field

Embodiments of the disclosure relate to an etching device and a method of manufacturing a window. More particularly, the disclosure relates to an etching device used to manufacture a foldable window and a method of manufacturing the foldable window.

### 2. Description of Related Art

A display device typically includes a display area that is activated in response to electrical signals. The display device may sense an input applied thereto from an outside through the display area and display images to provide a user with information through the display area. In recent years, display devices of a variety of shapes such as foldable display devices have been developed

### SUMMARY

A foldable display device may include an ultra-thin glass (UTG). Such an UTG may be desired to have foldable properties. Foldable properties of the UTG may be achieved by an etching method. Accordingly, an efficient etching method for the UTG is desired.

Embodiments of the disclosure provide an etching device capable of manufacturing a foldable window with improved reliability.

Embodiments of the disclosure provide a method of manufacturing the foldable window with improved reliability through a simplified process.

Embodiments of the invention provide an etching device including a stage on which a target substrate is disposed, a nozzle part disposed to face the stage with the target substrate interposed therebetween, where the nozzle part sprays an etching solution toward the stage, a mask part disposed between the target substrate and the nozzle part, where the mask part includes a first pattern including a first side surface extending in a first direction, a second pattern spaced apart from the first pattern in a second direction intersecting the first direction and including a second side surface extending in the first direction, and an opening is defined by the first side surface and the second side surface to expose a portion of the target substrate, and a lower cooling part disposed between the stage and the target substrate.

In an embodiment, the lower cooling part may include a first lower cooling pattern and a second lower cooling pattern spaced apart from the first lower cooling pattern in the second direction, and at least a portion of a separation space between the first lower cooling pattern and the second lower cooling pattern may overlap the opening when viewed in a plan view.

In an embodiment, the first lower cooling pattern may overlap the first side surface when viewed in the plan view, and the second lower cooling pattern may overlap the second side surface when viewed in the plan view.

In an embodiment, the first lower cooling pattern may overlap the first pattern when viewed in the plan view, and the second lower cooling pattern may overlap the second pattern when viewed in the plan view.

In an embodiment, the etching device may further include an upper cooling part including a first upper cooling pattern disposed on the first pattern and a second upper cooling pattern disposed on the second pattern.

In an embodiment, the first upper cooling pattern may be disposed directly on the first pattern, and the second upper cooling pattern may be disposed directly on the second pattern.

In an embodiment, the nozzle part may include a first nozzle overlapping each of the first pattern and the second pattern when viewed in the plan view and a second nozzle overlapping the opening when viewed in the plan view. In such an embodiment, the etching solution may include a first etching solution sprayed from the first nozzle and a second etching solution sprayed from the second nozzle.

In an embodiment, the first etching solution may have a temperature equal to or greater than about 10 degrees Celsius and equal to or less than about 20 degrees Celsius, and the second etching solution may have a temperature equal to or greater than about 30 degrees Celsius and equal to or less than about 40 degrees Celsius.

In an embodiment, the etching solution may include a fluorine compound.

In an embodiment, the lower cooling part may maintain a temperature equal to or greater than about 0 degrees Celsius and equal to or less than about 10 degrees Celsius.

In an embodiment, each of the first and second patterns may include a photoresist material.

Embodiments of the invention provide a method of manufacturing a window. In such embodiments, the method includes placing a lower cooling part on a stage, placing a target substrate on the lower cooling part, forming a mask part on the target substrate, where the mask part includes a first pattern including a first side surface extending in a first direction, and a second pattern spaced apart from the first pattern in a second direction intersecting the first direction and including a second side surface, and an opening is defined therethrough by the first and second side surfaces to expose a portion of the target substrate, and providing an etching solution onto the mask part and the portion of the target substrate exposed through the opening.

In an embodiment, the lower cooling part may maintain a temperature equal to or greater than about 0 degrees Celsius and equal to or less than about 10 degrees Celsius.

In an embodiment, the lower cooling part may overlap each of the first and second side surfaces when viewed in a plan view.

In an embodiment, the method may further include placing an upper cooling part on the mask part after the forming the mask part on the target substrate and before the providing the etching solution onto the mask part and the portion of the target substrate exposed through the opening may include a first upper cooling pattern disposed on the first pattern and a second upper cooling pattern disposed on the second pattern, the first upper cooling pattern may maintain a temperature equal to or greater than about 0 degrees Celsius and equal to or less than about 10 degrees Celsius and the second upper cooling pattern may maintain a temperature equal to or greater than about 0 degrees Celsius and equal to or less than about 10 degrees Celsius.

In an embodiment, the providing the etching solution to the mask part may include providing the etching solution onto the mask part through a nozzle part disposed to face the stage with the target substrate interposed therebetween and spraying the etching solution toward the stage.

In an embodiment, the nozzle part may include a first nozzle overlapping each of the first pattern and the second pattern when viewed in a plan view and a second nozzle overlapping the opening when viewed in the plan view, and the etching solution may include a first etching solution sprayed from the first nozzle and a second etching solution sprayed from the second nozzle.

In an embodiment, the first etching solution may have a temperature equal to or greater than about 10 degrees Celsius and equal to or less than about 20 degrees Celsius, and the second etching solution may have a temperature equal to or greater than about 30 degrees Celsius and equal to or less than about 40 degrees Celsius.

In an embodiment, the providing the etching solution onto the mask part may include dipping the portion of the target substrate exposed through the opening into the etching solution.

Embodiments of the invention provide an electronic device which provides an image including a display device including a display module and a window disposed above the display module, where the window is manufactured by a method including placing a lower cooling part on a stage, placing a target substrate on the lower cooling part, forming a mask part on the target substrate, wherein the mask part includes a first pattern including a first side surface extending in a first direction, and a second pattern spaced apart from the first pattern in a second direction intersecting the first direction and including a second side surface, and an opening is defined therethrough by the first and second side surfaces to expose a portion of the target substrate, on the target substrate, and providing an etching solution onto the mask part and the portion of the target substrate exposed through the opening.

According to embodiments of the etching device, the window with foldable property and improved reliability is manufactured using the lower cooling part, which is disposed on a lower surface of the target substrate in the etching device, through a simple process.

According to embodiments of the manufacturing method of the window, the window with foldable property and improved reliability is manufactured using the lower cooling part, which is disposed on the lower surface of the target substrate in the etching device, through a simple process, thereby improving the difficulty of the process.

### BRIEF DESCRIPTION OF THE DRAWINGS

The above and other features of embodiments of the disclosure will become readily apparent by reference to the following detailed description when considered in conjunction with the accompanying drawings, in which:

FIGS. 1A to 1C are perspective views of a display device according to an embodiment of the disclosure;

FIG. 2 is an exploded perspective view of a display device according to an embodiment of the disclosure;

FIGS. 3A and 3B are cross-sectional views of display devices taken along a line I-I′ of FIG. 2;

FIG. 4 is a perspective view of an etching device according to an embodiment of the disclosure;

FIGS. 5 to 8 are cross-sectional views of etching devices according to embodiments of the disclosure;

FIG. 9 is a flowchart illustrating a method of manufacturing a window according to an embodiment of the disclosure; and

FIGS. 10 to 18 are views of a method of manufacturing a window according to an embodiment of the disclosure.

FIG. 19 is schematic diagrams of various electronic device to which a display device including a window manufactured by the window manufacturing method according to an embodiment of the disclosure

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

In the disclosure, it will be understood that when an element (or area, layer, or portion) is referred to as being “connected to” or “coupled to” another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Meanwhile, in the disclosure, when an element is referred to as being “directly connected” to another element, there are no intervening elements present between a layer, film region, or substrate and another layer, film, region, or substrate. For example, the term “directly connected” may mean that two layers or two members are disposed without employing additional adhesive therebetween.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described with reference to accompanying drawings.

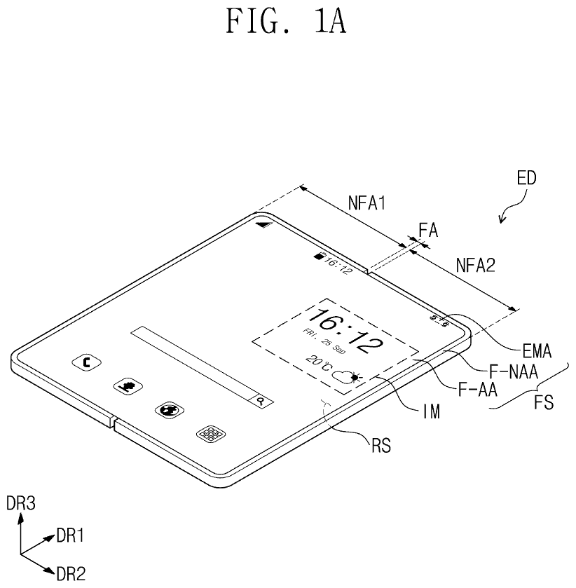

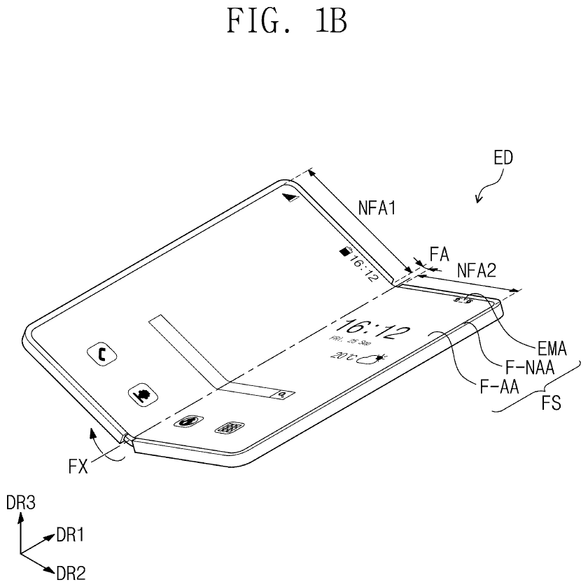

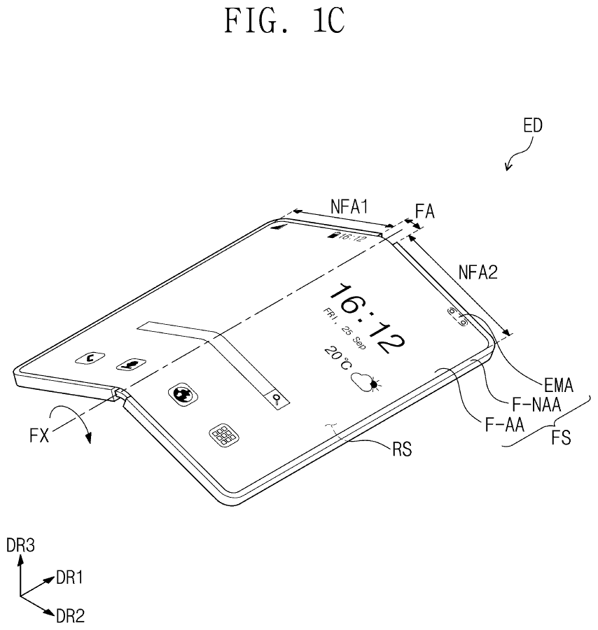

FIGS. 1A to 1C are perspective views of a display device ED according to an embodiment of the disclosure. FIG. 1A shows the display device ED in an unfolded state, and FIGS. 1B and 1C show the display device ED a folded state.

FIGS. 1A to 1C show an embodiment where the display device ED is a foldable display device as an example, however, the disclosure should not be limited thereto or thereby. The display device ED may be a flexible display device that is bendable or rollable.

The display device ED may include a display surface FS defined by a first direction DR1 and a second direction DR2 intersecting the first direction DR1. The display device ED may provide an image IM to a user through the display surface FS. The display device ED may display the image IM through the display surface FS, which is substantially parallel to each of the first direction DR1 and the second direction DR2, toward a third direction DR3. In the disclosure, the third direction DR3 may be a thickness direction of the display device ED.

The display surface FS of the display device ED may include an active area F-AA and a peripheral area F-NAA. The active area F-AA of the display device ED may be activated in response to electrical signals. The display device ED may display the image IM through the active area F-AA. In addition, various external inputs may be sensed through the active area F-AA. The peripheral area F-NAA may be defined adjacent to the active area F-AA. The peripheral area F-NAA may have a predetermined color. The peripheral area F-NAA may surround the active area F-AA when viewed on a plane or when viewed in a plan view (or when viewed in the third direction DR3). Accordingly, the active area F-AA may have a planar shape that is substantially defined by the peripheral area F-NAA, however, this is merely an example. In an embodiment, the peripheral area F-NAA may be defined adjacent to only one side of the active area F-AA or may be omitted. According to an embodiment, the display device ED may include the active area of various shapes, and it should not be particularly limited.

The active area F-AA may include a sensing area EMA. At least one selected from various electronic modules may be disposed in the sensing area EMA. In an embodiment, for example, the electronic module may include at least one selected from a camera module, a speaker, an optical sensor, and a thermal sensor. An external object may be sensed through the sensing area EMA of the display surface FS, or a sound signal, such as a voice, may be provided to the outside through the sensing area EMA of the display surface FS. In addition, the electronic module may include a plurality of components, and it should not be limited to a particular embodiment.

The sensing area EMA may be surrounded by the active area F-AA and the peripheral area F-NAA, however, it should not be limited thereto or thereby. The sensing area EMA may be defined in the active area F-AA, and it should not be particularly limited. FIG. 1A shows an embodiment where a single sensing area EMA is provided as an example, however, the number of the sensing areas EMA should not be limited thereto or thereby.

The sensing area EMA may be a portion of the active area F-AA. Accordingly, the display device ED may also display an image through the sensing area EMA. When the electronic modules disposed in the sensing area EMA are deactivated, the sensing area EMA may serve as the display surface to display the image.

In an embodiment, the display device ED may include a rear surface RS facing the display surface FS. The rear surface RS may be an external surface of the display device ED, and the image may not be displayed through the rear surface RS, however, it should not be limited thereto or thereby. According to another embodiment, the rear surface RS may serve as a second display surface through which the image is displayed. In addition, although not shown in figures, the display device ED may further include a sensing area defined in the rear surface RS. A camera, a speaker, or an optical sensor may be disposed in the sensing area defined in the rear surface RS.

The display device ED may include a folding area FA and non-folding areas NFA1 and NFA2. The display device ED may include a plurality of non-folding areas NFA1 and NFA2. According to an embodiment, the display device ED may include first and second non-folding areas NFA1 and NFA2 disposed adjacent to each other with the folding area FA interposed therebetween. FIGS. 1A to 1C show an embodiment where the display device ED includes a single folding area FA, however, the disclosure should not be limited thereto or thereby. According to an embodiment, the display device ED may include a plurality of folding areas defined therein. According to an embodiment, the display device ED may be folded or foldable with respect to a plurality of folding axes to allow portions of the display surface FS to face each other, and the number of the folding axes and the number of the non-folding areas should not be particularly limited.

Referring to FIGS. 1B and 1C, the display device ED may be folded with respect to a folding axis FX extending in one direction. The folding axis FX shown in FIGS. 1B and 1C may be an imaginary axis extending in the first direction DR1 to be substantially parallel to a direction in which a long side of the display device ED extends. However, the direction in which the folding axis FX extends should not be limited to the first direction DR1.

The folding axis FX may extend in the first direction DR1 on the display surface FS or may extend in the first direction DR1 under the rear surface RS. In an embodiment, referring to FIG. 1B, the display device ED may be inwardly folded (in-folding) to allow the first non-folding area NFA1 and the second non-folding area NFA2 to face each other, and thus, the display surface FS may not be exposed to the outside. In an embodiment, referring to FIG. 1C, the display device ED may be outwardly folded (out-folding) with respect to the folding axis FX to allow a portion of the rear surface RS, which overlaps the first non-folding area NFA1, to face the other portion of the rear surface RS, which overlaps the second non-folding area NFA2.

The display device ED may be configured to repeat the unfolding operation and the in-folding operation or to repeat the unfolding operation and the out-folding operation, however, the disclosure should not be limited thereto or thereby. According to an embodiment, the display device ED may be selectively operated in any one of the unfolding operation, the in-folding operation, and the out-folding operation.

FIGS. 1A to 1C show an embodiment where the display device ED is foldable with respect to the folding axis FX substantially parallel to the long side of the display device ED, however, the disclosure should not be limited thereto or thereby. According to another embodiment, the display device ED may be foldable with respect to a folding axis substantially parallel to a short side of the display device ED.

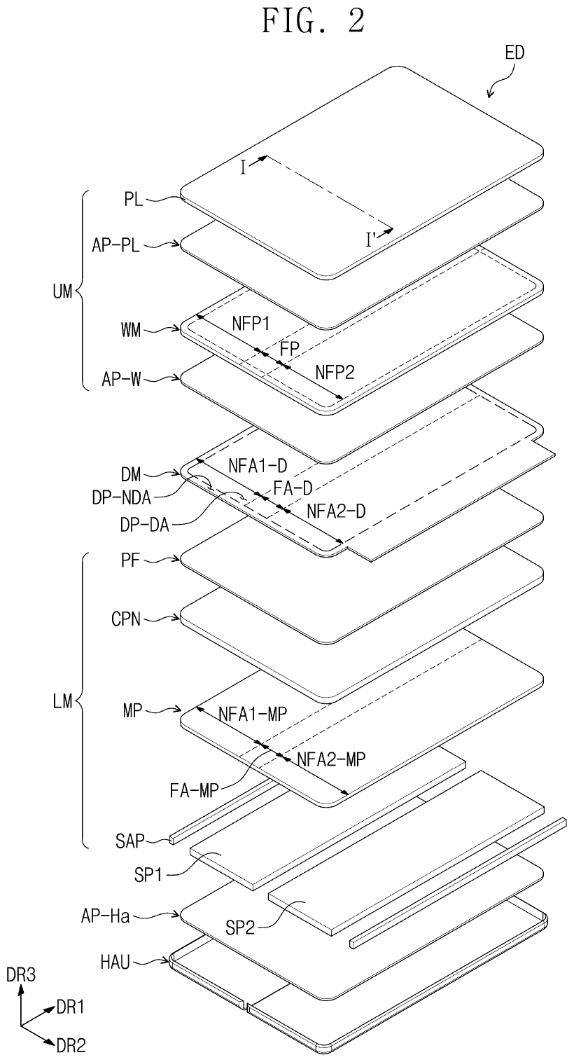

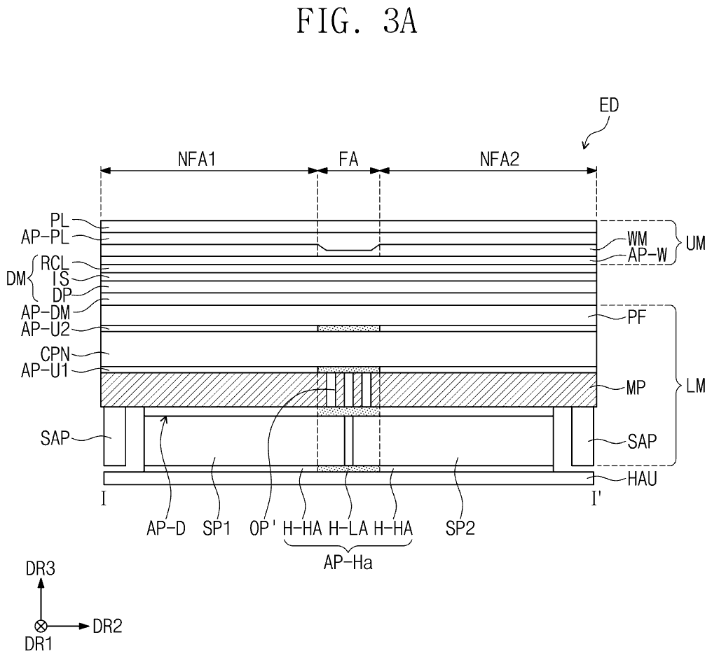

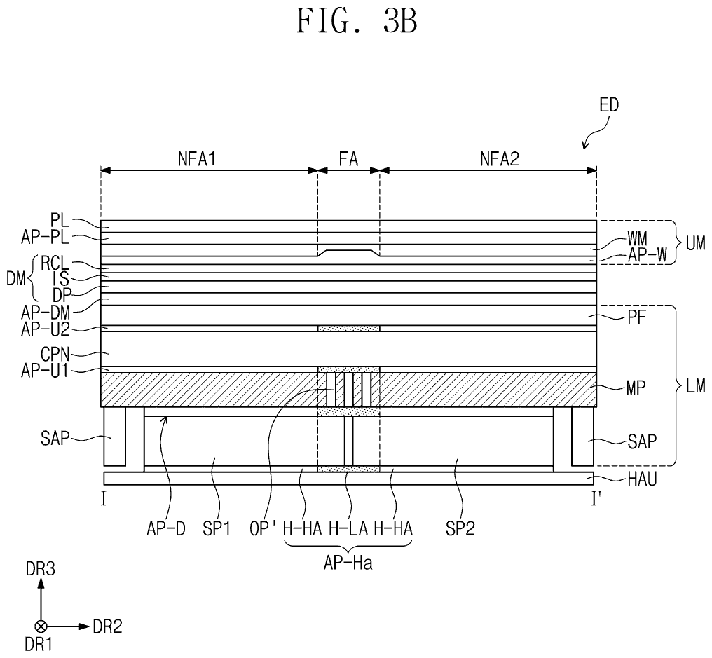

FIG. 2 is an exploded perspective view of the display device ED according to an embodiment of the disclosure, and FIGS. 3A and 3B are cross-sectional views of display devices. FIG. 2 is an exploded perspective view of the display device ED shown in FIG. 1A. FIGS. 3A and 3B are cross-sectional views of display devices taken along line I-I′ of FIG. 2. The display device ED shown in FIG. 3B is substantially the same as the display device ED shown in FIG. 3A except that a concave pattern is formed under a window.

Referring to FIGS. 2 to 3B, an embodiment of the display device ED may include a display module DM, an upper module UM disposed above the display module DM, and a lower module LM disposed under the display module DM.

The upper module UM disposed above the display module DM may function as a protective part to protect the display module DM from external impacts or may function as an optical part to effectively prevent reflection by external light or to increase light extraction efficiency.

The upper module UM may include a window WM disposed above the display module DM, a protective layer PL disposed above the window WM, and a protective layer adhesive layer AP-PL disposed between the window WM and the protective layer PL.

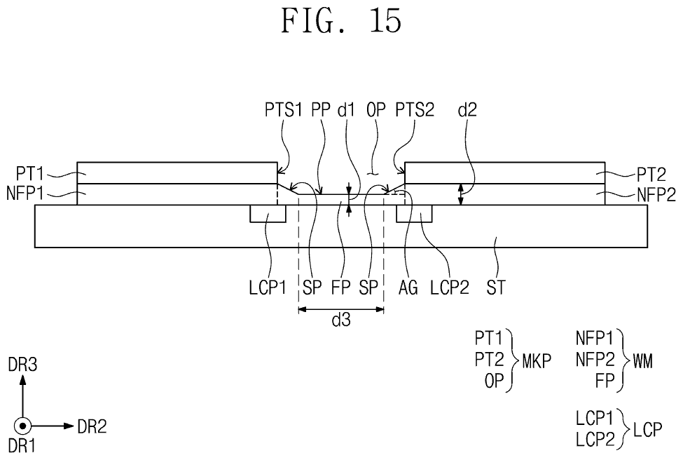

The window WM may cover an entire upper surface of the display module DM. The window WM may have a shape corresponding to a shape of the display module DM. The window WM of the display device ED may include an optically transparent insulating material. The window WM may include a glass substrate or a polymer substrate. In an embodiment, for example, the window WM may be a tempered glass substrate. According to an embodiment of the window WM, a step difference (or a stepped structure) may be formed between a folding portion FP thereof corresponding to the folding area FA and non-folding portions NFP1 and NFP2 thereof corresponding to the non-folding areas NFA1 and NFA2 to contribute to the folding characteristics of the display device ED. The step difference between the folding portion FP and the non-folding portions NFP1 and NFP2 of the window WM may be formed by forming a concave pattern in an upper surface of the window WM as shown in FIG. 3A or by forming a concave pattern in a lower surface of the window WM as shown in FIG. 3B. According to an embodiment of the window WM, the step difference between the folding portion FP and the non-folding portions NFP1 and NFP2 may be reduced, and thus, a distortion in image between a display area DP-DA and a non-display area DP-NDA of the display device ED may be improved. The shape of the window WM will be described in detail with reference to FIG. 15.

In an embodiment, the upper module UM may further include a window adhesive layer AP-W disposed under the window WM. The window adhesive layer AP-W may be disposed between the display module DM and the window WM. The window adhesive layer AP-W may be an optically clear adhesive (OCA) film or an optically clear adhesive resin (OCR) layer. According to another embodiment, the window adhesive layer AP-W may be omitted.

The protective layer PL may be disposed above the window WM and may protect the window WM from external environments. The protective layer PL may be transparent, and thus, image information provided from the display module DM may be viewed even though the protective layer PL is disposed thereon. The protective layer PL may be an uppermost surface of the display device ED to be exposed, and the protective layer PL may be damaged depending on the use of the display device ED.

The protective layer PL may have an optical characteristic having a transmittance of about 90% or greater in a visible light region and a haze value of less than about 1%. The protective layer PL may include a polymer film. In an embodiment, the protective layer PL may include a polymer film as a base layer and may further include a functional layer such as a hard coating layer, an anti-fingerprint coating layer, an antistatic coating layer, or the like on the base layer. The protective layer PL used in the display device ED may have flexibility.

The protective layer PL may be a polymer film including at least one polymer resin selected from polyethylene terephthalate (PET), polybutylene terephthalate (PBT), polyethylene naphthalene (PEN), polycarbonate (PC), polymethylmethacrylate (PMMA), polystyrene (PS), polyvinylchloride (PVC), polyethersulfone (PES), polypropylene (PP), polyamide (PA), modified polyphenylene ether (m-PPO), polyoxymethylene (POM), polysulfone (PSU), polyphenylene sulfide (PPS), polyimide (PI), polyethyleneimine (PEI), polyether ether ketone (PEEK), polyamide imide (PAI), polyarylate (PAR), and thermoplastic polyurethane (TPU).

In an embodiment, for example, the protective layer PL may be a polyethylene terephthalate (PET) film or a thermoplastic polyurethane (TPU) film. In an embodiment, for example, the protective layer PL may be a PET film without a phase delay.

According to an embodiment of the display device ED, the protective layer adhesive layer AP-PL may be disposed between the window WM and the protective layer PL. The protective layer adhesive layer AP-PL may be an optically clear adhesive layer. The protective layer adhesive layer AP-PL may be attached to the window WM to fix the protective layer PL to the window WM.

The display device ED in an embodiment may include a housing HAU that accommodates the display module DM and the lower module LM. The housing HAU may be coupled to the window WM. Although not shown, the housing HAU may further include a hinge structure for effective or efficient folding or bending. The hinge structure may be disposed to correspond to the folding area FA.

The display device ED in an embodiment may include a housing adhesive layer AP-Ha. The housing adhesive layer AP-Ha may function to fix the lower module LM to the housing HAU. In an embodiment, the housing adhesive layer AP-Ha may include a folding adhesive portion H-LA corresponding to the folding area FA and non-folding adhesive portions H-HA corresponding to the non-folding areas NFA1 and NFA2. The housing adhesive layer AP-Ha may be an adhesive member to allow the lower module LM to be coupled to the housing HAU and may also function as an electromagnetic shielding layer or a heat dissipation layer.

The display module DM included in the display device ED may generate an image and may sense an input applied thereto from the outside. The display module DM may include a display panel DP and an input sensor IS disposed on the display panel DP. In addition, the display module DM may further include an optical layer RCL disposed on the input sensor IS.

The display panel DP may have a configuration that substantially generates the image. The display panel DP may be a light emitting type display panel. In an embodiment, for example, the display panel DP may be an organic light emitting display panel, an inorganic light emitting display panel, a quantum dot display panel, a micro-light emitting diode (LED) display panel, or a nano-LED display panel. The display panel DP may be referred to as a display layer.

The input sensor IS may be disposed on the display panel DP. The input sensor IS may sense an external input applied thereto from the outside. The external input may be a user input. The user input may include various forms of external inputs, such as a part of a user's body, light, heat, pen, or pressure.

In an embodiment, the input sensor IS may be formed on the display panel DP through successive processes. In such an embodiment, the input sensor IS may be expressed as being disposed directly on the display panel DP. The expression that the input sensor IS is disposed directly on the display panel DP may mean that no third component is disposed between the input sensor IS and the display panel DP. That is, a separate adhesive member may not be disposed between the input sensor IS and the display panel DP. According to an embodiment, the input sensor IS may be coupled to the display panel DP by an adhesive member. The adhesive member may be a conventional adhesive.

The optical layer RCL may be disposed on the input sensor IS. The optical layer RCL may be an anti-reflective layer to reduce a reflectance of the display module DM with respect to the external light incident into the display module DM. In an embodiment, the optical layer RCL may be formed on the input sensor IS through successive processes. The optical layer RCL may include a polarizer or a color filter layer. According to an embodiment, the optical layer RCL may include pigments or dyes and may absorb a light in a specific wavelength range. In an embodiment where the optical layer RCL includes the color filter layer, the color filter layer may include a plurality of color filters arranged in a predetermined arrangement. In an embodiment, for example, the color filters may be arranged by taking into account colors of lights emitted from pixels included in the display panel DP. In addition, the optical layer RCL may further include a partition pattern to distinguish the pixels of the display panel DP from each other. The partition pattern may include a black pigment or dye. According to an embodiment, the optical layer RCL may be omitted.

The display module DM may include the display area DP-DA and the non-display area DP-NDA. The display area DP-DA may be defined as an area in which the image provided from the display module DM is displayed.

The non-display area DP-NDA may be defined adjacent to the display area DP-DA. In an embodiment, for example, the non-display area DP-NDA may surround the display area DP-DA when viewed in the plan view, however, this is merely an example. According to an embodiment, the non-display area DP-NDA may have various shapes and should not be particularly limited. The display area DP-DA of the display module DM may correspond to at least a portion of the active area F-AA (refer to FIG. 1A).

According to an embodiment of the display device ED, the display module DM may include a folding display portion FA-D and non-folding display portions NFA1-D and NFA2-D. The folding display portion FA-D may correspond to the folding area FA (refer to FIG. 1A), and the non-folding display portions NFA1-D and NFA2-D may correspond to the non-folding areas NFA1 and NFA2 (refer to FIG. 1A).

The folding display portion FA-D may be folded or bent with respect to the folding axis FX (refer to FIG. 1B). The display module DM may include a first non-folding display portion NFA1-D and a second non-folding display portion NFA2-D, and the first non-folding display portion NFA1-D and the second non-folding display portion NFA2-D may be spaced apart from each other with the folding display portion FA-D interposed therebetween.

In an embodiment, the display device ED may further include a module adhesive layer AP-DM disposed between the display module DM and the lower module LM. The module adhesive layer AP-DM may be an optically clear adhesive (OCA) film or an optically clear adhesive resin (OCR) layer.

According to an embodiment of the display device ED, the lower module LM may include a support plate MP and adhesive layers AP-U1, AP-U2, and AP-D disposed on and under the support plate MP. In addition, the lower module LM may include at least one of support portions SP1 and SP2, a filling portion SAP, a module protective layer PF, and a buffer layer CPN. In an embodiment, for example, the display device ED may include the support plate MP disposed under the display module DM, the module protective layer PF and the buffer layer CPN disposed between the support plate MP and the display module DM, and the support portions SP1 and SP2 and the filling portion SAP disposed under the support plate MP.

The support plate MP may be disposed under the display module DM. The support plate MP may include a folding support portion FA-MP and non-folding support portions NFA1-MP and NFA2-MP. In the following descriptions, the folding support portion FA-MP may be referred to as a folding portion, and the non-folding support portions NFA1-MP and NFA2-MP may be referred to as non-folding portions. A first non-folding portion NFA1-MP and a second non-folding portion NFA2-MP of the support plate MP may be spaced apart from each other with the folding portion FA-MP interposed therebetween. The folding portion FA-MP may correspond to the folding area FA, and the non-folding portions NFA1-MP and NFA2-MP may correspond to the non-folding areas NFA1 and NFA2.

The support plate MP may include a metal material or polymer material. In an embodiment, for example, the support plate MP may include stainless steel, aluminum, or an alloy thereof. In addition, according to an embodiment, the support plate MP may include a carbon fiber reinforced plastic (CFRP), however, the disclosure should not be limited thereto or thereby. According to an embodiment, the support plate MP may include at least one selected from a non-metallic material, a plastic material, a glass fiber reinforced plastic, or a glass material.

The support plate MP may be provided with a plurality of openings OP′ defined therethrough. The openings OP′ may be defined to correspond to the folding area FA.

The module protective layer PF may be disposed between the display module DM and the support plate MP. The module protective layer PF may be disposed under the display module DM and may protect a rear surface of the display module DM. The module protective layer PF may entirely overlap the display module DM. The module protective layer PF may include a polymer material. In an embodiment, for example, the module protective layer PF may be a polyimide film or a polyethylene terephthalate film, however, materials for the module protective layer PF should not be limited thereto or thereby.

The display device ED may include the support portions SP1 and SP2 and the filling portion SAP. The support portions SP1 and SP2 may overlap most of the display module DM. The filling portion SAP may be disposed outside the support portions SP1 and SP2 and may overlap an outer portion of the display module DM.

The support portions SP1 and SP2 may include a first sub-support portion SP1 and a second sub-support portion SP2 spaced apart from the first sub-support portion SP1 in the second direction DR2. The first sub-support portion SP1 and the second sub-support portion SP2 may be spaced apart from each other in an area corresponding to the folding axis FX (refer to FIG. 1B). In an embodiment where the support portions SP1 and SP2 are provided as the first sub-support portion SP1 and the second sub-support portion SP2 that are spaced apart from each other in the folding area FA, the folding or bending characteristics of the display device ED may be improved. In an embodiment, although not shown in figures, the lower module LM may further include a cushion layer (not shown) disposed on or under the support portions SP1 and SP2. The cushion layer (not shown) may include sub-cushion layers separated from each other in an area corresponding to the folding axis FX (refer to FIG. 1B). A lower adhesive layer in which an adhesive force in an area corresponding to the folding area FA is less than an adhesive force in an area corresponding to the non-folding areas NFA1 and NFA2 may be further disposed between the support portions SP1 and SP2 and the cushion layer (not shown).

The cushion layer (not shown) may effectively prevent the support plate MP from being pressed and deformed by external impact and force. The cushion layer (not shown) may include a sponge, a foam, or an elastomer such as a urethane resin. In addition, the cushion layer (not shown) may include at least one selected from an acrylic-based polymer, a urethane-based polymer, a silicon-based polymer, and an imide-based polymer, however, it should not be limited thereto or thereby. According to an embodiment, the cushion layer (not shown) may be disposed under the support plate MP or under a lower support plate (not shown).

The filling portion SAP may be disposed outside the support portions SP1 and SP2. The filling portion SAP may be disposed between the support plate MP and the housing HAU. The filling portion SAP may be filled in a space between the support plate MP and the housing HAU to fix the support plate MP.

The display device ED may include the buffer layer CPN included in the lower module LM. The buffer layer CPN may serve as a thickness compensation layer to compensate for the difference in thickness of the components disposed under the display module DM or a support layer to support the display module DM. In another embodiment, the buffer layer CPN may be omitted.

A combination of components included in the lower module LM of the display device ED should not be limited thereto or thereby and may vary depending on the size, shape, and operating characteristics of the display device ED. In an embodiment, for example, the lower module LM may further include additional components, such as a support plate, a cushion member, an adhesive layer, and the like.

The lower module LM of the display device ED may include one or more upper adhesive layers AP-U1 and AP-U2 disposed above the support plate MP and at least one lower adhesive layer AP-D disposed under the support plate MP.

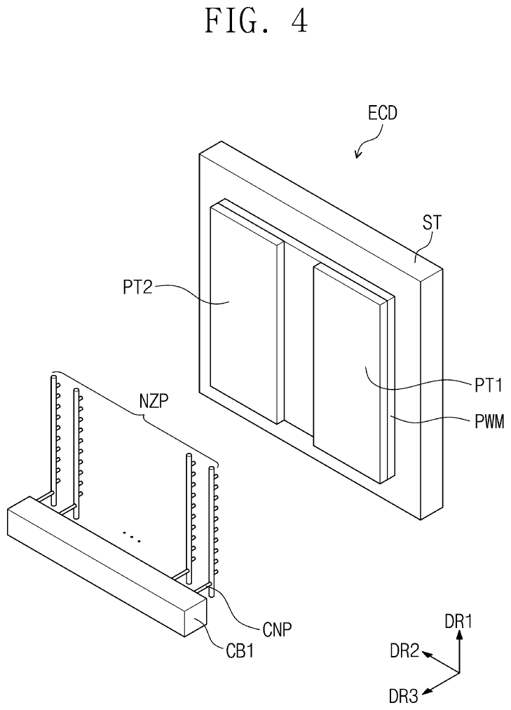

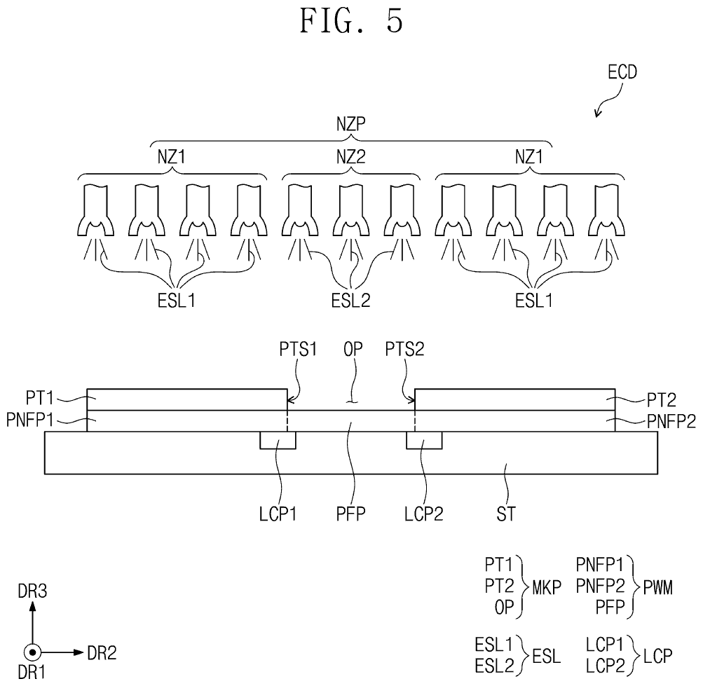

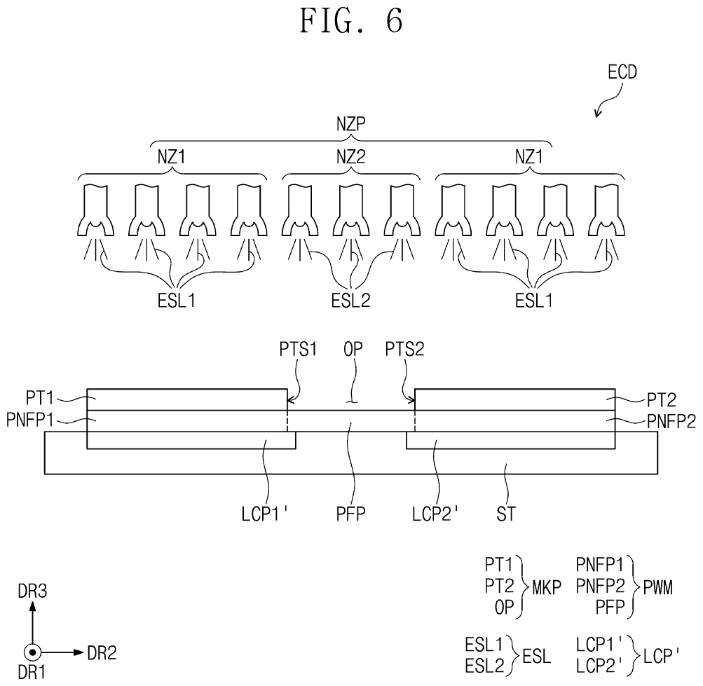

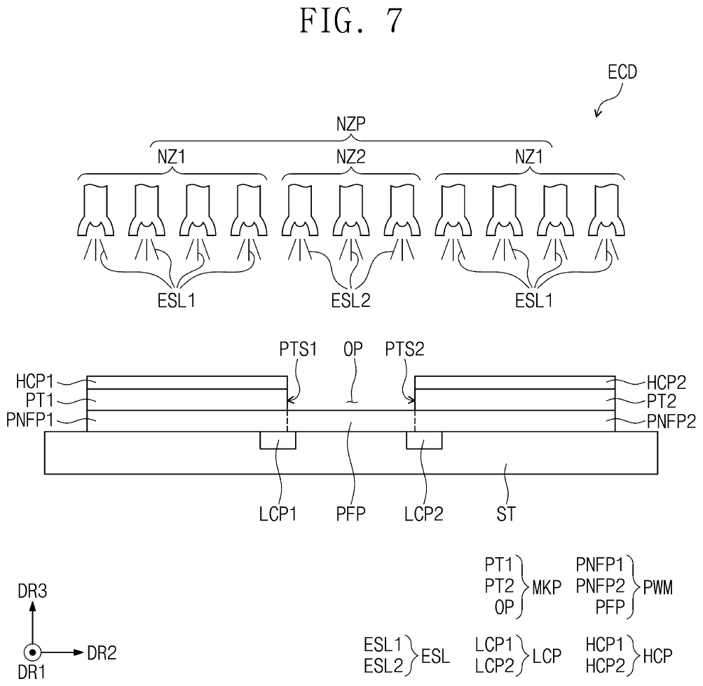

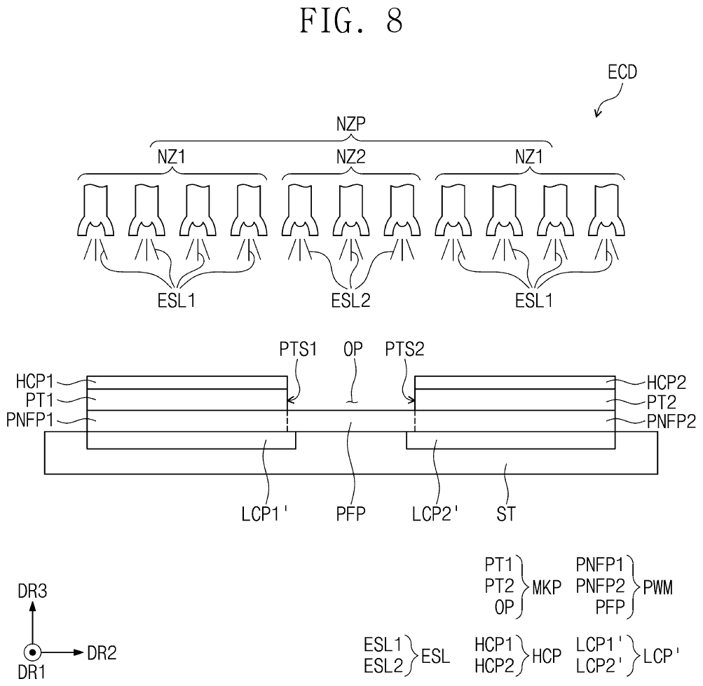

FIG. 4 is a perspective view of an etching device ECD according to an embodiment of the disclosure, and FIGS. 5 to 8 are cross-sectional views of etching devices according to embodiments of the disclosure. FIG. 6 shows an embodiment having a structure in which a lower cooling part overlaps a first pattern and a second pattern when viewed in the plan view. FIG. 7 shows an embodiment having a structure in which the etching device ECD further includes a first upper cooling pattern disposed on a first pattern and a second upper cooling pattern disposed on a second pattern. FIG. 8 shows an embodiment having a structure in which a lower cooling part overlaps a first pattern and a second pattern when viewed in the plan view.

Referring to FIGS. 4 and 5, an embodiment of the etching device ECD may include a stage ST, a nozzle part NZP, a mask part MKP, and a lower cooling part LCP.

A target substrate PWM may be disposed on the stage ST. The stage ST may provide a base surface to which the target substrate PWM is fixed. The stage ST may include an acid-resistance material. The acid-resistance material may include plastic. The stage ST may include or be formed of plastic. The stage ST may not be etched by an etching solution ESL described later. In an embodiment, the stage ST may be large enough to accommodate multiple target substrates PWM thereon.

The target substrate PWM may be the window WM (refer to FIG. 3A) described above according to the use of the etching device ECD of the disclosure. The target substrate PWM may include a first preliminary non-folding portion PNFP1, a second preliminary non-folding portion PNFP2 spaced apart from the first preliminary non-folding portion PNFP1 when viewed in the plan view, and a preliminary folding portion PFP disposed between the first preliminary non-folding portion PNFP1 and the second preliminary non-folding portion PNFP2 when viewed in the plan view. The first preliminary non-folding portion PNFP1 may correspond to the first non-folding area NFA1 (refer to FIG. 1A). The second preliminary non-folding portion PNFP2 may correspond to the second non-folding area NFA2 (refer to FIG. 1A). The preliminary folding portion PFP may correspond to the folding area FA (refer to FIG. 1A).)

A first chamber CB1 may provide a space to store the etching solution ESL. The connection part CNP may connect the first chamber CB1 and the nozzle part NZP. The connection part CNP may serve as a passage to transmit the etching solution ESL stored in the first chamber CB1 to the nozzle part NZP. The nozzle part NZP may be disposed to face the stage ST with the target substrate PWM interposed therebetween and may spray the etching solution ESL to the stage ST. The nozzle part NZP may include an acid-resistance material. The acid-resistance material may include plastic. The nozzle part NZP may include or be formed of plastic. The nozzle part NZP may include a first nozzle NZ1 and a second nozzle NZ2. The first nozzle NZ1 may overlap a first pattern PT1 and a second pattern PT2 described later when viewed in the plan view. The second nozzle NZ2 may overlap an opening OP described later when viewed in the plan view. For convenience of illustration, FIG. 5 shows eight first nozzles NZ1 and three second nozzles NZ2, however, the number of the first nozzles NZ1 and the number of second nozzles NZ2 should not be limited thereto or thereby.

The etching solution ESL may include a fluorinated compound. In an embodiment, for example, the etching solution ESL may include hydrofluoric acid or ammonium hydrogen fluoride. At least a portion of the target substrate PWM may dissolve by the etching solution. The etching solution ESL may include a first etching solution ESL1 sprayed from the first nozzle NZ1 and a second etching solution ESL2 sprayed from the second nozzle NZ2. The second etching solution ESL2 may have a temperature higher than a temperature of the first etching solution ESL1. The temperature of the first etching solution ESL1 may be equal to or greater than about 10 degrees Celsius and equal to or less than about 20 degrees Celsius. The temperature of the second etching solution ESL2 may be equal to or greater than about 30 degrees Celsius and equal to or less than about 40 degrees Celsius. When the temperature of the second etching solution ESL2 is lower than the temperature of the first etching solution ESL1, the etching solution ESL having a relatively high temperature may be provided to a center of the preliminary folding portion PFP, and the etching solution ESL having a relatively low temperature may be provided to a periphery of the preliminary folding portion PFP. The etching reaction of the high-temperature etching solution ESL is more active than that of the low-temperature etching solution ESL, the step difference between the folding portion FP (refer to FIG. 15) and the non-folding portions NFP1 and NFP2 (refer to FIG. 15) may be reduced, and thus, a surface distortion of the display device ED (refer to FIG. 3A) may be improved.

The mask part MKP may include the first pattern PT1 and the second pattern PT2, and the opening OP is defined therebetween. The mask part MKP may be disposed between the target substrate PWM and the nozzle part NZP. The mask part MKP may be disposed on the target substrate PWM and may guide the etching solution sprayed by the nozzle part NZP to be appropriately coated on the target substrate PWM. The mask part MKP may be disposed directly on the target substrate PWM.

The first pattern PT1 may be disposed on the first preliminary non-folding portion PNFP1. The first pattern PT1 may be disposed directly on the first preliminary non-folding portion PNFP1. The first pattern PT1 may have substantially the same size as a size of the first preliminary non-folding portion PNFP1 when viewed in the plan view. The first pattern PT1 may include a photoresist material. The first etching solution ESL1 may be provided onto the first pattern PT1. The first pattern PT1 may include a material that is not dissolved by the etching solution ESL. In an embodiment, for example, the first pattern PT1 may include a positive photoresist material. The first pattern PT1 may include a first side surface PTS1. The first side surface PTS1 may extend in the first direction DR1. The first side surface PTS1 may be aligned with a boundary between the first preliminary non-folding portion PNFP1 and the preliminary folding portion PFP when viewed in the plan view.

The second pattern PT2 may be disposed on the second preliminary non-folding portion PNFP2. The second pattern PT2 may be disposed directly on the second preliminary non-folding portion PNFP2. The second pattern PT2 may have substantially the same size as a size of the second preliminary non-folding portion PNFP2 when viewed in the plan view. The second pattern PT2 may include a photoresist material. The first etching solution ESL1 may be provided onto the second pattern PT2. The second pattern PT2 may include a material that is not dissolved by the etching solution ESL. In an embodiment, for example, the second pattern PT2 may include a positive photoresist material. The second pattern PT2 may include a second side surface PTS2. The second side surface PTS2 may extend in the first direction DR1. The second side surface PTS2 may be aligned with a boundary between the second preliminary non-folding portion PNFP2 and the preliminary folding portion PFP when viewed in the plan view. The second side surface PTS2 may face the first side surface PTS1.

The opening OP may be defined by the first side surface PTS1 and the second side surface PTS2. A portion of the target substrate PWM may be exposed through the opening OP. The preliminary folding portion PFP may be exposed through the opening OP. The opening OP may have substantially the same size as that of the preliminary folding portion PFP when viewed in the plan view. The etching solution ESL may be sprayed from the nozzle part NZP and may be provided to the preliminary folding portion PFP through the opening OP. The second etching solution ESL2 may be sprayed from the second nozzle NZ2 and may be provided to the preliminary folding portion PFP through the opening OP.

The lower cooling part LCP may be disposed between the stage ST and the target substrate PWM. The lower cooling part LCP may be disposed directly on a lower surface of the target substrate PWM. The lower cooling part LCP may be disposed in a groove formed in an upper surface of the stage. The lower cooling part LCP may include a metal material. The lower cooling part LCP may maintain (or be maintained at) a temperature equal to or greater than about 0 degrees Celsius and equal to or less than about 10 degrees Celsius. The etching device ECD including the lower cooling part LCP may slow down a chemical reaction that causes the etching solution ESL to etch a portion of the target substrate PWM, and thus, the step difference between the folding portion FP (refer to FIG. 15) and the non-folding portions NFP1 and NFP2 (refer to FIG. 15) of the window WM (refer to FIG. 15) may be reduced. The lower cooling part LCP may include a first lower cooling pattern LCP1 and a second lower cooling pattern LCP2. The second lower cooling pattern LCP2 may be spaced apart from the first lower cooling pattern LCP1 in the second direction DR2. At least a portion of a separation space between the first lower cooling pattern LCP1 and the second lower cooling pattern LCP2 may overlap the opening OP when viewed in the plan view. The first lower cooling pattern LCP1 may overlap the first side surface PTS1 when viewed in the plan view. The first lower cooling pattern LCP1 may overlap at least a portion of the first preliminary non-folding portion PNFP1 when viewed in the plan view. The first lower cooling pattern LCP1 may overlap a portion of the preliminary folding portion PFP when viewed in the plan view. The second lower cooling pattern LCP2 may overlap the second side surface PTS2 when viewed in the plan view. The second lower cooling pattern LCP2 may overlap at least a portion of the second preliminary non-folding portion PNFP2 when viewed in the plan view. The second lower cooling pattern LCP2 may overlap a portion of the preliminary folding portion PFP when viewed in the plan view. The first lower cooling pattern LCP1 and the second lower cooling pattern LCP2 may be disposed in grooves defined or formed in the upper surface of the stage ST, respectively.

Hereinafter, descriptions with reference to FIGS. 6 to 8 will be focused on different features from the etching device ECD shown in FIG. 5.

Referring to FIG. 6, an embodiment of the etching device ECD may include the lower cooling part LCP′ including a first lower cooling pattern LCP1′ and a second lower cooling pattern LCP2′. The first lower cooling pattern LCP1′ may entirely overlap the first pattern PT1 when viewed in the plan view, and the second lower cooling pattern LCP2′ may entirely overlap the second pattern PT2. A size of an area where the lower cooling part LCP′ is in contact with the first pattern PT1 and the second pattern PT2 may be greater than a size of an area where the lower cooling part LCP shown in FIG. 5 is in contact with the first pattern PT1 and the second pattern PT2, and thus, a reaction rate of an etching solution ESL may be easily controlled. One end of the first lower cooling pattern LCP1′ may be aligned with one end of a first preliminary non-folding portion PFNP1 when viewed in the plan view. One end of the second lower cooling pattern LCP2′ may be aligned with one end of a second preliminary non-folding portion PFNP2 when viewed in the plan view. The first lower cooling pattern LCP1′ and the second lower cooling pattern LCP2′ may be disposed in grooves defined or formed in an upper surface of a stage ST, respectively.

Referring to FIG. 7, an embodiment of the etching device ECD may further include an upper cooling part HCP. The upper cooling part HCP may include a first upper cooling pattern HCP1 and a second upper cooling pattern HCP2. The first upper cooling pattern HCP1 may be disposed on the first pattern PT1. The first upper cooling pattern HCP1 may be disposed directly on the first pattern PT1. The second upper cooling pattern HCP2 may be disposed on the second pattern PT2. The second upper cooling pattern HCP2 may be disposed directly on the second pattern PT2. The second upper cooling pattern HCP2 may be spaced apart from the first upper cooling pattern HCP1 in the second direction DR2. One end of the first upper cooling pattern HCP1 may be aligned with a first side surface PTS1 when viewed in the plan view. One end of the second upper cooling pattern HCP2 may be aligned with a second side surface PTS2 when viewed in the plan view. The first upper cooling pattern HCP1 may have substantially the same size as a size of the first pattern PT1 when viewed in the plan view. The second upper cooling pattern HCP2 may have substantially the same size as a size of the second pattern PT2 when viewed in the plan view. Each of the first upper cooling pattern HCP1 and the second upper cooling pattern HCP2 may maintain (or be maintained at) a temperature equal to or greater than about 0 degrees Celsius and equal to or less than about 10 degrees Celsius. The etching device ECD including the upper cooling part HCP may slow down a chemical reaction that causes the etching solution ESL to etch a portion of a target substrate PWM, and thus, a step difference between a folding portion (refer to FP of FIG. 15) and non-folding portions (refer to NFP1 and NFP2 of FIG. 15) of a window (refer to WM of FIG. 15) may be reduced.

Referring to FIG. 8, an embodiment of the etching device ECD may include the lower cooling part LCP′ and an upper cooling part HCP. Descriptions on the lower cooling part HCP′ of FIG. 6 may be equally applied to the lower cooling part LCP′ shown in FIG. 8. Descriptions on the upper cooling part HCP of FIG. 7 may be equally applied to the upper cooling part HCP shown in FIG. 8.

Hereinafter, a manufacturing method of the window using the etching device according to an embodiments will be described in detail, and any repetitive detailed descriptions of the same or like elements as those described above with reference to FIGS. 1A to 8 will be omitted.

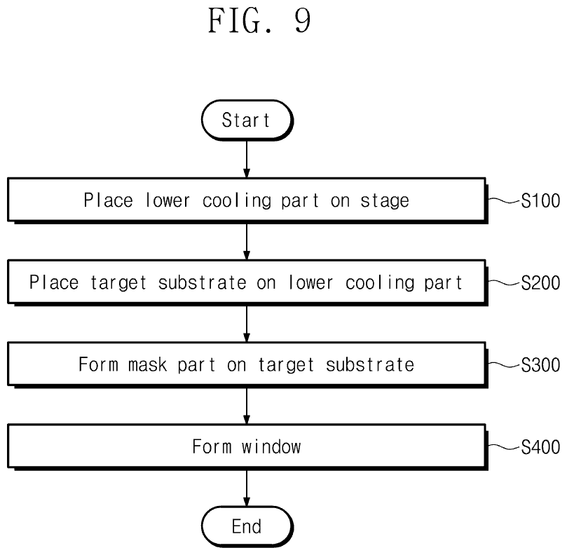

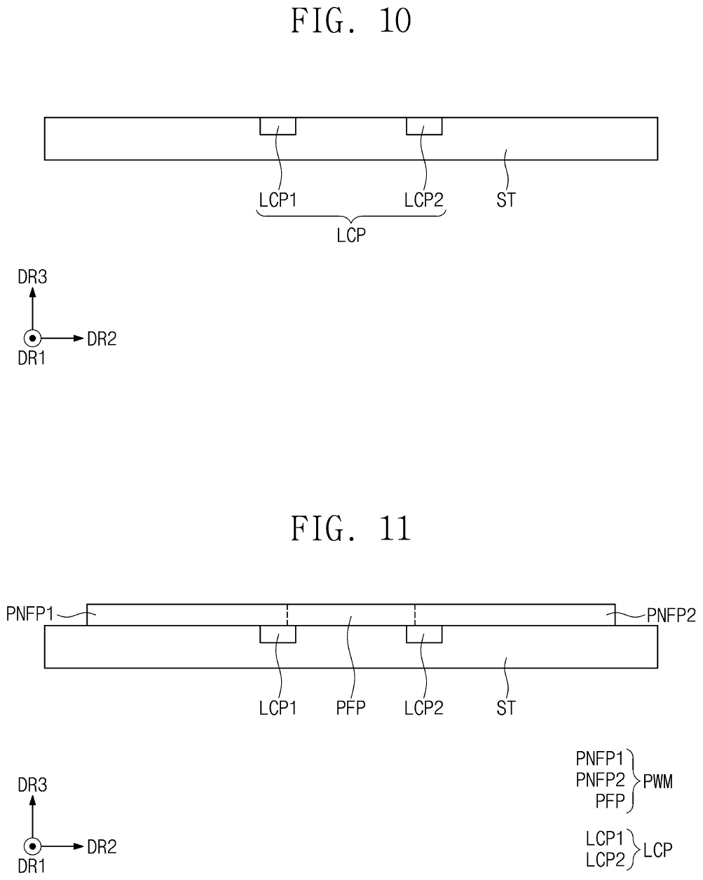

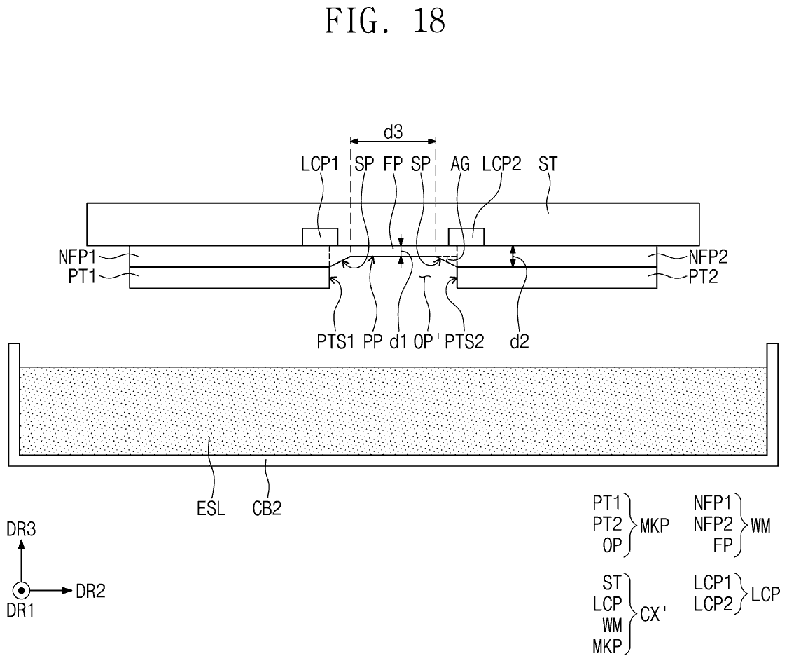

FIG. 9 is a flowchart illustrating the method of manufacturing the window according to an embodiment of the disclosure. FIGS. 10 to 18 are views of the method of manufacturing the window according to an embodiment of the disclosure.

Referring to FIG. 9, an embodiment of the manufacturing method of the window includes placing the lower cooling part on the stage (S100), placing the target substrate on the lower cooling part (S200), forming the mask part on the target substrate (S300), and forming the window (S400). The display device ED (refer to FIG. 2), including the window WM (refer to FIG. 2) manufactured by method of manufacturing the window can be applied to various electronic devices.

Referring to FIG. 10, the lower cooling part LCP may be disposed directly on the stage ST in the placing of the lower cooling part LCP on the stage ST. The lower cooling part LCP may be disposed in the groove defined or formed in the upper surface of the stage ST. The lower cooling part LCP may maintain (or be maintained at) the temperature equal to or greater than about 0 degrees Celsius and equal to or less than about 10 degrees Celsius in subsequent processes. In an embodiment, the lower cooling part LCP′ (refer to FIG. 6) may be disposed to substantially overlap the target substrate PWM.

Referring to FIG. 11, at least a portion of the target substrate PWM may be disposed directly on the lower cooling part LCP in the placing of the target substrate PWM on the lower cooling part LCP. One portion of the target substrate PWM may be disposed directly on the lower cooling part LCP, and another portion of the target substrate PWM may be disposed directly on the stage ST. The target substrate PWM may be disposed to allow the boundary of the first preliminary non-folding portion PNFP1 and the preliminary folding portion PFP to overlap the first lower cooling pattern LCP1. The target substrate PWM may be disposed to allow the boundary of the second preliminary non-folding portion NFP2 and the preliminary folding portion PFP to overlap the second lower cooling pattern LCP2. The target substrate PWM may include the material that is dissolved by the etching solution ESL (refer to FIG. 5). The target substrate PWM may include the glass material. Although not shown in figures, the stage ST may further include an additional component to fix the target substrate PWM thereonto.

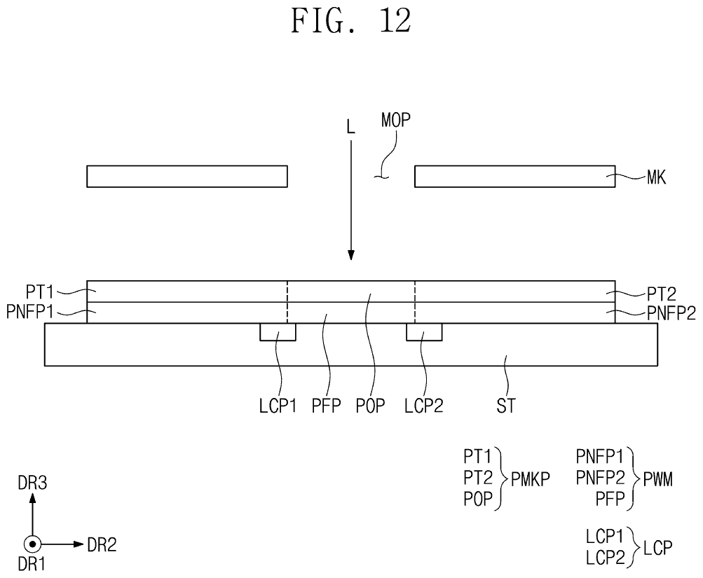

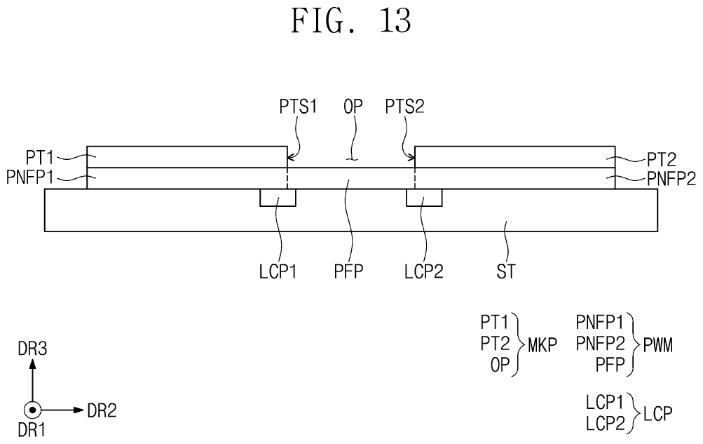

Referring to FIGS. 12 and 13, the forming of the mask part MKP on the target substrate PWM may include forming a preliminary mask part PMKP on the target substrate PWM and removing a portion (hereinafter, referred to as a preliminary opening POP) where the opening OP is to be formed. In the forming of the preliminary mask part PMKP on the target substrate PWM, the preliminary mask part PMKP may be disposed directly on the target substrate PWM. The preliminary mask part PMKP may include a photoresist material. In an embodiment, for example, the preliminary mask part PMKP may include a positive photoresist material. The preliminary mask part PMKP may include the first pattern PT1, the second pattern PT2, and the preliminary opening POP. In the removing of the preliminary opening POP, a photomask MK provided with a mask opening MOP defined therethrough and overlapping the preliminary opening POP may be disposed above the preliminary mask part PMKP. In an embodiment, when a light L is provided to the preliminary opening POP through the mask opening MOP, the preliminary opening POP may be removed to form the mask part MKP. In another embodiment, the preliminary mask part PMKP may include a negative photoresist material. In such an embodiment where the preliminary mask part PMKP includes the negative photoresist material, the preliminary opening POP may be removed by radiating the light L to the first pattern PT1 and the second pattern PT2 and developing the first pattern PT1 and the second pattern PT2.

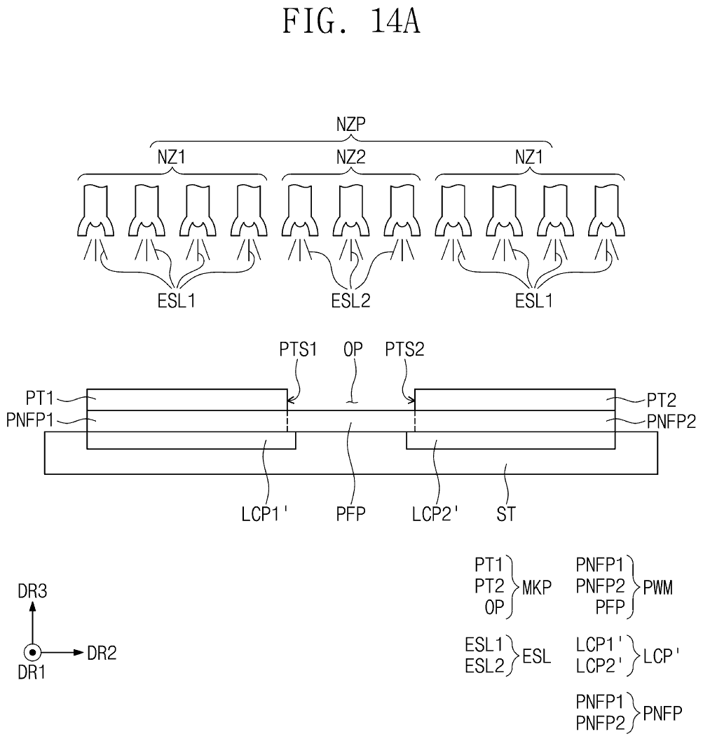

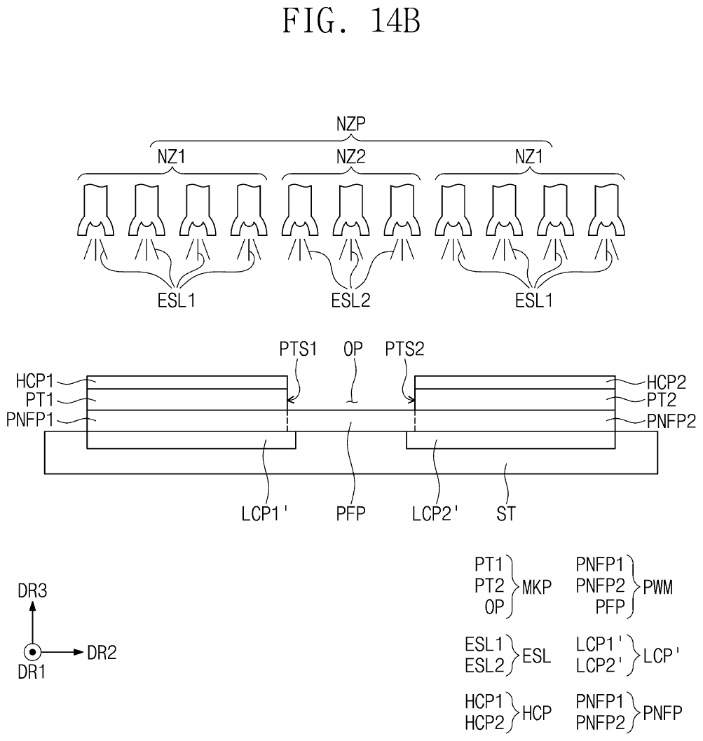

Referring to FIGS. 14A and 15, in the forming of the window, the etching solution ESL may be provided to the mask part MKP and the portion of the target substrate PWM exposed through the opening OP. The etching solution ESL may be sprayed by the nozzle part NZP. The first etching solution ESL1 sprayed by the first nozzle NZ1 may have the temperature equal to or greater than about 10 degrees Celsius and equal to or less than about 20 degrees Celsius. The second etching solution ESL2 sprayed by the second nozzle NZ may have the temperature equal to or greater than about 30 degrees Celsius and equal to or less than about 40 degrees Celsius. A portion of the first etching solution ESL1 may be mixed with the second etching solution ESL2 and may be provided to the preliminary folding portion PFP. Since the temperature of the etching solution ESL provided to the periphery of the preliminary folding portion PFP is lower than the temperature of the etching solution ESL provided to the center of the preliminary folding portion PFP, an etch rate of the portions where the preliminary folding portion PFP and the preliminary non-folding portion PNFP are adjacent to each other may be slower than an etch rate of the center of the preliminary folding portion PFP, and thus, the step difference between the folding portion FP and the non-folding portions NFP1 and NFP2 of the window WM may be reduced.

In an embodiment, as shown in FIG. 15, the folding portion FP may have a thickness d1 less than a thickness d2 of the non-folding portions NFP1 and NFP2. The thickness d1 of the folding portion FP may be a minimum value obtained by measuring the thickness of the folding portion FP in the third direction DR3. A difference between the thickness d1 of the folding portion FP and the thickness d2 of the non-folding portions NFP1 and NFP2 may be less than about 7 micrometers (mm). The folding portion FP may include a flat surface PP and a slant (or inclined) surface SP. The flat surface PP may be substantially parallel to the plan view defined by the first direction DR1 and the second direction DR2. The slant surface SP may be a surface connecting the flat surface PP and each of the first non-folding portion NFP1 and the second non-folding portion NFP2.

The flat surface PP may have a width d3 equal to or greater than about 1 mm and equal to or less than about 25 mm in the second direction DR2. In an embodiment, for example, the width d3 of the flat surface PP in the second direction DR2 may be about 10 mm. An angle AG between the flat surface PP and the slant surface SP may be equal to or greater than about 0.1 degrees and less than about 0.4 degrees. In an embodiment, for example, the angle AG between the flat surface PP and the slant surface SP may be about 0.2 degrees. A step difference between the flat surface PP and an upper surface of the first non-folding portion NFP1 or the second non-folding portion NFP2 may be equal to or greater than about 0.001 mm and equal to or than about 0.007 mm. The step difference between the flat surface PP and the upper surface of the first non-folding portion NFP1 or the second non-folding portion NFP2 may be a difference between the thickness d2 of the non-folding portions NFP1 and NFP2 and the thickness d1 of the folding portion FP. In an embodiment, for example, the step difference between the flat surface PP and the upper surface of the first non-folding portion NFP1 or the second non-folding portion NFP2 may be about 0.003 mm. Since the angle between the flat surface PP and the slant surface SP of the window WM manufactured by the manufacturing method according to the disclosure is equal to or greater than about 0.1 degrees and equal to or less than about 0.4 degrees, the angle between the flat surface PP and the slant surface SP of the window WM manufactured by the manufacturing method according to an embodiment of the disclosure may be gentler or less than an angle between a flat surface and a slant surface of a conventional window. Accordingly, the image distortion occurring at a boundary between the folding area FA (refer to FIG. 1A) and the non-folding areas NFA1 and NFA2 (refer to FIG. 1A) of the display device ED (refer to FIG. 1A) may be improved. When the angle between the flat surface PP and the slant surface SP is less than about 0.1 degrees, the folding characteristics of the window WM may be deteriorated. When the angle between the flat surface PP and the slant surface SP is greater than about 0.4 degrees, the image distortion occurring at the boundary between the folding area FA (refer to FIG. 1A) and the non-folding areas NFA1 and NFA2 (refer to FIG. 1A) of the display device ED (refer to FIG. 1A) may not be improved.

Referring to FIGS. 14B and 15, an embodiment of the manufacturing method of the window may further include placing the upper cooling part HCP on the mask part MKP between the forming of the mask part MKP on the target substrate PWM and the forming of the window WM. The upper cooling part HCP may maintain (or be maintained at) the temperature equal to or greater than about 0 degrees Celsius and equal to or less than about 10 degrees Celsius. Since the upper cooling part HCP may be disposed directly on the mask part MKP, an etch rate of a portion where the preliminary folding portion PFP and the preliminary non-folding portion PNFP are adjacent to each other may be slower than an etch rate of a center of the preliminary folding portion PFP, and thus, the step difference between the folding portion FP and the non-folding portions NFP1 and NFP2 of the window WM may be reduced.

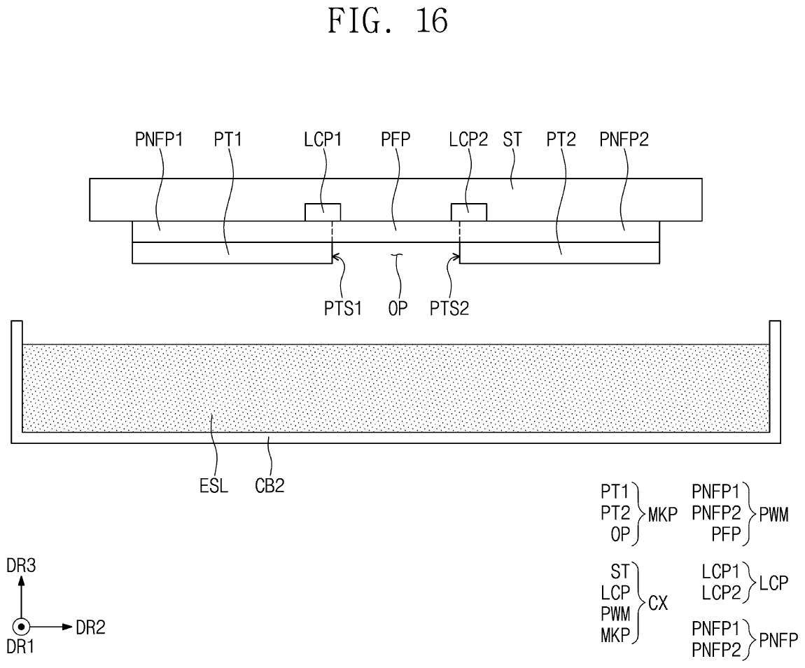

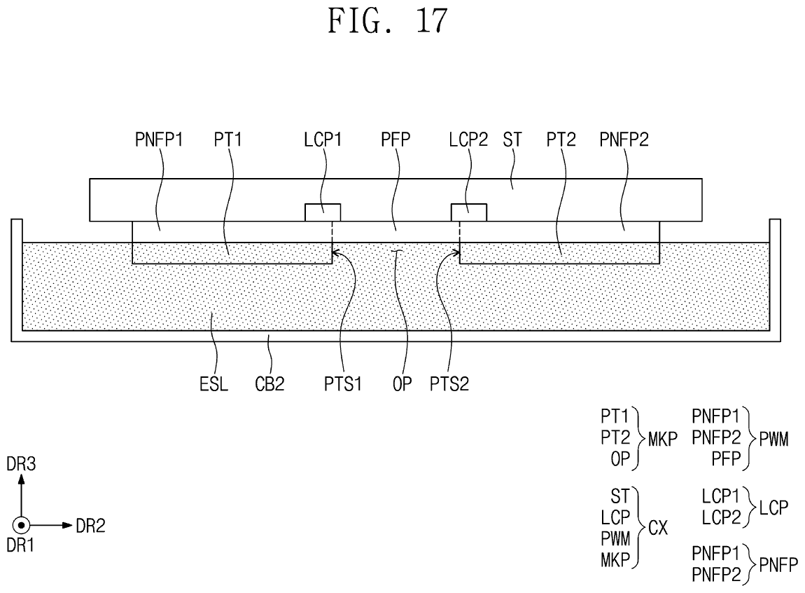

Referring to FIGS. 16 to 18, in an embodiment, the forming of the window WM may include dipping the portion of the target substrate PWM exposed through the opening OP into the etching solution ESL. A complex CX may include the stage ST, the lower cooling part LCP, the target substrate PWM, and the mask part MKP. The etching solution ESL may be filled into a second chamber CB2. In the dipping of the preliminary folding portion PFP into the etching solution ESL, the user may adjust the complex CX to allow the mask part MFP to face downward. The user may slowly move the complex CX to a direction opposite to the third direction DR3 to dip the preliminary folding portion PFP into the etching solution ESL through the opening OP of the complex CX. In another embodiment, the user may further move the complex CX to the direction opposite to the third direction DR3 than that shown in FIG. 17 to sufficiently provide the etching solution ESL onto the preliminary folding portion PFP. Then, a portion of the preliminary folding portion PFP may be etched, and the window WM may be formed.

After the window WM is formed, the user may move the complex CX′ including the window WM to the third direction DR3. In the dipping of the complex CX into the etching solution ESL, the lower cooling part LCP may be disposed on the lower surface of the target substrate PWM to allow the etch rate of the portion where the preliminary folding portion PFP and the preliminary non-folding portion PNFP are adjacent to each other to be slower than the etch rate of the center of the preliminary folding portion PFP, and thus, the window WM in which the step difference between the folding portion FP and the non-folding portions NFP1 and NFP2 is reduced may be formed.

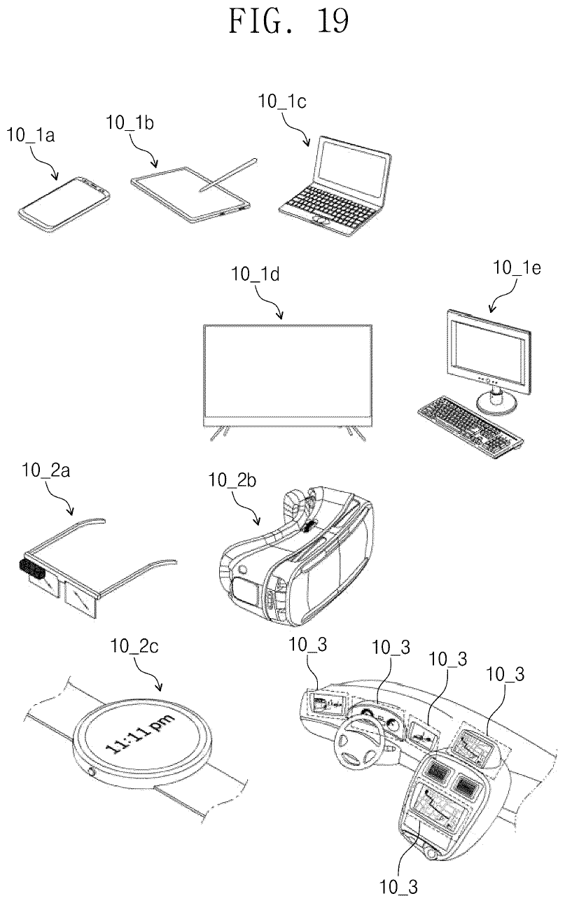

FIG. 19 is schematic diagrams of various electronic device to which a display device including a window manufactured by the window manufacturing method according to an embodiment of the disclosure.

Referring to FIG. 19, the display device ED according to an embodiment of the invention may be applied to various electronic devices. For example, various electronic devices to which the display device ED according to an embodiment is applied may include electronic devices for displaying images, such as a smartphone 10_1a, a tablet computer 10_1b, a laptop computer 10_1c, a television (TV) 10_1d, and a desktop monitor 10_1e.

In addition, various electronic devices to which the display device ED according to one embodiment is applied may include wearable electronic devices, such as smart glasses 10_2a, a head-mounted display 10_2b, and a smart watch 10_2c.

Furthermore, various electronic devices to which the display device ED according to an embodiment is applied may include automotive electronic devices 10_3, such as a center information display (CID) arranged on a dashboard, center fascia, or instrument cluster of a vehicle, as well as a room mirror display.

According to embodiments of the manufacturing method of the window, the window having the foldable characteristics and improved reliability may be simply manufactured using the lower cooling part disposed under the target substrate, and a difficulty of the manufacturing process may be improved.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An etching device comprising:
a stage on which a target substrate is disposed;
a nozzle part disposed to face the stage with the target substrate interposed therebetween, wherein the nozzle part sprays an etching solution toward the stage;
a mask part disposed between the target substrate and the nozzle part, wherein the mask part comprises a first pattern comprising a first side surface extending in a first direction, and a second pattern spaced apart from the first pattern in a second direction intersecting the first direction and comprising a second side surface extending in the first direction, wherein an opening is defined by the first side surface and the second side surface to expose a portion of the target substrate; and
a lower cooling part disposed between the stage and the target substrate.

2. The etching device of claim 1, wherein
the lower cooling part comprises a first lower cooling pattern and a second lower cooling pattern spaced apart from the first lower cooling pattern in the second direction, and
at least a portion of a separation space between the first lower cooling pattern and the second lower cooling pattern overlaps the opening when viewed in a plan view.

3. The etching device of claim 2, wherein
the first lower cooling pattern overlaps the first side surface when viewed in the plan view, and
the second lower cooling pattern overlaps the second side surface when viewed in the plan view.

4. The etching device of claim 2, wherein
the first lower cooling pattern overlaps the first pattern when viewed in the plan view, and
the second lower cooling pattern overlaps the second pattern when viewed in the plan view.

5. The etching device of claim 1, further comprising:
an upper cooling part comprising a first upper cooling pattern disposed on the first pattern and a second upper cooling pattern disposed on the second pattern.

6. The etching device of claim 5, wherein
the first upper cooling pattern is disposed directly on the first pattern, and
the second upper cooling pattern is disposed directly on the second pattern.

7. The etching device of claim 1, wherein the nozzle part comprises:
a first nozzle overlapping each of the first pattern and the second pattern when viewed in a plan view; and
a second nozzle overlapping the opening when viewed in the plan view, and
wherein the etching solution comprises:
a first etching solution sprayed from the first nozzle; and
a second etching solution sprayed from the second nozzle.

8. The etching device of claim 7, wherein
the first etching solution has a temperature equal to or greater than about 10 degrees Celsius and equal to or less than about 20 degrees Celsius, and
the second etching solution has a temperature equal to or greater than about 30 degrees Celsius and equal to or less than about 40 degrees Celsius.

9. The etching device of claim 1, wherein the etching solution comprises a fluorine compound.

10. The etching device of claim 1, wherein the lower cooling part maintains a temperature equal to or greater than about 0 degrees Celsius and equal to or less than about 10 degrees Celsius.

11. The etching device of claim 1, wherein each of the first and second patterns comprises a photoresist material.

12. A method of manufacturing a window, the method comprising:
placing a lower cooling part on a stage;
placing a target substrate on the lower cooling part;
forming a mask part on the target substrate, wherein the mask part comprises a first pattern comprising a first side surface extending in a first direction, and a second pattern spaced apart from the first pattern in a second direction intersecting the first direction and comprising a second side surface, and an opening is defined therethrough by the first and second side surfaces to expose a portion of the target substrate; and
providing an etching solution onto the mask part and the portion of the target substrate exposed through the opening.

13. The method of claim 12, wherein the lower cooling part maintains a temperature equal to or greater than about 0 degrees Celsius and equal to or less than about 10 degrees Celsius.

14. The method of claim 12, wherein the lower cooling part overlaps each of the first and second side surfaces when viewed in a plan view.

15. The method of claim 12, further comprising:
placing an upper cooling part on the mask part after the forming the mask part on the target substrate and before the providing the etching solution onto the mask part and the portion of the target substrate exposed through the opening, wherein the upper cooling part comprises a first upper cooling pattern disposed on the first pattern and a second upper cooling pattern disposed on the second pattern, the first upper cooling pattern maintains a temperature equal to or greater than about 0 degrees Celsius and equal to or less than about 10 degrees Celsius, and the second upper cooling pattern maintains a temperature equal to or greater than about 0 degrees Celsius and equal to or less than about 10 degrees Celsius.

16. The method of claim 12, wherein the providing the etching solution to the mask part comprises providing the etching solution onto the mask part through a nozzle part disposed to face the stage with the target substrate interposed therebetween and spraying the etching solution toward the stage.

17. The method of claim 16, wherein the nozzle part comprises:
a first nozzle overlapping each of the first pattern and the second pattern when viewed in a plan view; and
a second nozzle overlapping the opening when viewed in the plan view, and the etching solution comprises:
a first etching solution sprayed from the first nozzle; and
a second etching solution sprayed from the second nozzle.

18. The method of claim 17, wherein the first etching solution has a temperature equal to or greater than about 10 degrees Celsius and equal to or less than about 20 degrees Celsius, and the second etching solution has a temperature equal to or greater than about 30 degrees Celsius and equal to or less than about 40 degrees Celsius.

19. The method of claim 12, wherein the providing the etching solution onto the mask part comprises dipping the portion of the target substrate exposed through the opening into the etching solution.

20. An electronic device which provides an image, the electronic device comprising:
a display device comprising:
a display module; and
a window disposed above the display module, wherein the window is manufactured by a method comprising:
placing a lower cooling part on a stage;
placing a target substrate on the lower cooling part;
forming a mask part on the target substrate, wherein the mask part comprises a first pattern comprising a first side surface extending in a first direction, and a second pattern spaced apart from the first pattern in a second direction intersecting the first direction and comprising a second side surface, and an opening is defined therethrough by the first and second side surfaces to expose a portion of the target substrate; and
providing an etching solution onto the mask part and the portion of the target substrate exposed through the opening.
